(19) United States
(12) Patent Application Publication
(10) Pub. No.: US 2026/0326935 A1
(43) Pub. Date: Oct. 22, 2026

(54) AUTONOMOUS AND COOPERATIVE MULTI-AGENT SYSTEMS FOR PREDICTIVE AND CO-EVOLUTIONARY THREAT MANAGEMENT

(71) Applicant: Richard Joseph Mitchell, TAVARES, FL (US)

(72) Inventor: Richard Joseph Mitchell, TAVARES, FL (US)

(21) Appl. No.: 19/373,566

(22) Filed: Oct. 29, 2025

(51) Int. Cl. B64U 20/80; B64U 10/40; B64U 101/40; G05D 1/698; G05D 101/15; G05D 105/35; G05D 105/50; G05D 109/20; H04L 9/40

(52) U.S. Cl. CPC B64U 20/80; B64U 10/40; G05D 1/6987; H04L 63/1441; B64U 2101/40; B64U 2201/10; G05D 2101/15; G05D 2105/35; G05D 2105/50; G05D 2109/265

(57) ABSTRACT

A system for autonomous and cooperative multi-agent management comprises a control station orchestrating clusters of autonomous agents. The system uses a centralized-training, decentralized-execution framework for adaptive threat management. For wildlife deterrence, a Co-Evolutionary Adaptation Module (CEAM) generates novel, unpredictable tactics by modeling and anticipating wildlife habituation, measured against quantified anti-habituation objectives. In cybersecurity, autonomous software agents implement moving-target defense, with strategies selected by a game-theoretic engine that uses a learned, predictive model of specific adversary behavior, comprising a hidden Markov model of a cyber-attack, to calculate optimal responses at a Stackelberg equilibrium. Event-overwatch embodiments provide geofenced monitoring based on predictive threat vector analysis. The architecture supports autonomous docking and recharge, logs auditable telemetry, and enforces safety interlocks, affording continuous, fail-operational coverage with adaptive role rotation and learning across missions.

### CROSS-REFERENCE TO RELATED APPLICATIONS

This application is related to U.S. patent application titled ‘SYSTEM AND METHOD FOR A UNIFIED, EVIDENTIARY ARTIFICIAL INTELLIGENCE ARCHITECTURE’ and U.S. patent application titled ‘REDUNDANT CONTROL ARCHITECTURE FOR MULTI-DOMAIN AUTONOMOUS AGENTS’. The collection of these inventions constitutes the AURA (Autonomous Unified Reliability Architecture) platform, forming a cohesive patent family.

### BACKGROUND OF THE INVENTION

### 1. Technical Field

The present invention relates generally to the field of autonomous systems. More specifically, the invention pertains to a command-and-control architecture for multi-agent systems that solves the technical problems of target habituation and adversary prediction in dynamic, adversarial environments, including but not limited to wildlife deterrence, cybersecurity, and event security.

### 2. Background Art

The effective management of dynamic threats, whether from wildlife, human adversaries, or cyber attackers, is a persistent and cross-domain technical challenge. A common thread uniting these disparate fields is the adaptive nature of the threat. Intelligent subjects, whether biological or artificial, are capable of learning, adapting, and ultimately overcoming static or predictable management systems. This adaptive capability creates a fundamental technical barrier that has limited the long-term efficacy of prior art solutions.

In domains such as aviation, agriculture, and renewable energy, the conflict between human activity and wildlife incurs significant economic and safety costs. In aviation, wildlife strikes to civil aircraft result in substantial recurring financial losses. In agriculture and aquaculture, avian predation leads to major yield and stock losses. At wind energy facilities, the risk of avian collision with turbine blades forces costly operational shutdowns, known as curtailment. A vast array of deterrent methods has been developed, ranging from simple scarecrows and propane cannons to more advanced static laser and acoustic devices.

However, these methods consistently fail over the long term due to a single, pervasive technical problem: habituation. Habituation is not merely an inconvenience but a fundamental, universal form of learning preserved across species.¹ It is a behavioral process that allows an organism to cease responding to repetitive, irrelevant stimuli, thereby freeing up cognitive resources for other stimuli that are associated with biologically important events.¹ This process is characterized by a decrease in neural activity, often referred to as neural adaptation or repetition suppression, as a stimulus is repeated.² Consequently, Intelligent wildlife, particularly avian species, possess sophisticated learning capabilities that enable them to quickly discern that a predictable stimulus, not associated with a genuine, credible threat, can be safely ignored. This learning process, which can be context-specific, renders conventional deterrents ineffective as the target animals become accustomed to the repetitive, non-threatening patterns. Habituation is therefore not a simple design flaw in animals but a core feature of intelligent biological systems that undermines capital investment in deterrent technologies and leaves critical assets vulnerable.

A parallel and non-obvious technical problem exists in the domain of cybersecurity. Here, the challenge is not an adaptive animal, but an intelligent human adversary, often part of a well-resourced group known as an Advanced Persistent Threat (APT). Traditional cyber defenses, much like static scarecrows, rely on predictable configurations. Firewalls have fixed rule sets, servers have static IP addresses, and network topologies remain unchanged for long periods. An APT can learn the characteristics of a static defense posture, much like a flock of birds learns the timing of a propane cannon. Cyber deception techniques, such as “honeypots,” were developed to counter attackers by creating decoy systems. However, these static decoys are often easily identifiable by skilled adversaries due to their lack of realism, predictable behavior, and isolation from the production network. Once the defense is predictable, it can be bypassed. This highlights a parallel unmet need for dynamic, unpredictable, and adaptive defense mechanisms, a concept known as Moving Target Defense (MTD), that can counter an intelligent adversary's ability to learn and adapt.

Prior art solutions have failed to adequately address this core, cross-domain problem of predictability. The prior art has evolved to include single autonomous agents, such as AI-driven drones, to address the shortcomings of static deterrents. While these single-agent systems represent an advancement, they are still fundamentally limited. A single drone, regardless of how its payload or flight path is adapted, presents a singular and ultimately predictable threat vector. A collective intelligence, such as a flock of birds or a team of hackers, can observe, learn, and adapt its own behavior to counter the patterns and limitations of a single perceived threat. The core technical limitation remains: a single agent lacks the ability to exert the complex, multi-directional, and coordinated pressure characteristic of a true predatory threat.

Generic multi-agent “herding” systems are also known in the art but are similarly deficient. For example, Patent Application WO2022009208A1 teaches a cooperative system for “herding” species but is limited to simplistic behaviors that rely on applying a generalized repulsive force to the perimeter of a group. These systems do not teach or suggest the implementation of complex, multi-role, predator-prey dynamics that create an authentic, fear-based stimulus. They lack the behavioral sophistication required to generate a truly unpredictable and non-habituating deterrent.

This analysis of the prior art reveals a significant “unpredictability gap.” The market has components for sensing (e.g., cameras, Intrusion Detection Systems) and for acting (e.g., drones, firewalls), but it lacks a unified control system capable of generating computationally robust unpredictability to win a long-term intelligence race against an adaptive adversary. The core failure of the prior art is not one of hardware, but of the controlling intelligence. There remains a long-felt but unsolved need for a system that moves beyond single-agent adaptation and generic herding to create a truly intelligent, cooperative, and unpredictable management system that directly solves the critical, industry-wide problems of habituation and predictability.

### BRIEF SUMMARY OF THE INVENTION

The present invention provides innovative systems and methods for the autonomous, cooperative, and adaptive command and control of multiple autonomous agents, designed to overcome the critical limitations of prior art by generating emergent, unpredictable behaviors. The invention addresses the fundamental technical problems of habituation to predictable deterrents and the circumvention of static defenses by intelligent adversaries.

A key aspect of the invention is a system comprising a managed cluster of autonomous agents, a control station, and a novel artificial intelligence (AI) control system. The AI control system is configured to execute a multi-agent reinforcement learning (MARL) model, enabling the cluster of agents to perform cooperative swarm behaviors. A central feature of these behaviors is the dynamic assignment of roles to individual agents based on real-time tactical conditions, allowing the swarm to execute complex, coordinated, and unpredictable maneuvers.

In a principal embodiment for wildlife deterrence, the invention introduces a novel Co-Evolutionary Adaptation Module (CEAM). The CEAM is a proactive system that maintains a predictive habituation model of the target wildlife, allowing it to anticipate how the target species will adapt to deterrent stimuli. The system then engages in a co-evolutionary process, using a genetic algorithm to computationally evolve and generate novel and unpredictable deterrent tactics specifically designed to counter the predicted adaptation of the wildlife. This creates a dynamic “arms race” between the deterrent system and the target, ensuring long-term effectiveness and overcoming the limitations of systems that rely on a fixed repertoire of actions.

In a principal embodiment for cybersecurity, the invention introduces a Predictive Adversarial Modeling framework. This framework utilizes the MARL system to learn a predictive model of a specific, active adversary's tactics, techniques, and procedures (TTPs), for example by using a Hidden Markov Model to represent the stages of a cyber-attack. This learned model is then integrated into a game-theoretic engine, which models the interaction as a Stackelberg game. The system calculates optimal Moving Target Defense (MTD) strategies not against a generic rational adversary, but against the predicted next actions of the specific adversary engaging the network. This predictive capability represents a significant advancement over reactive or simple randomized security protocols.

By generating computationally robust unpredictability, the present invention overcomes the specific deficiencies of habituation and predictability that plague prior art systems.

### BRIEF DESCRIPTION OF THE SEVERAL VIEWS OF THE DRAWING

The accompanying drawings, which are incorporated in and constitute a part of this specification, illustrate embodiments of the disclosure and, together with the description, serve to explain the principles of the disclosure.

FIG. 1 is a schematic system architecture diagram illustrating an exemplary deployment of the system.

FIG. 2 is a perspective view of a biomimetic ornithopter UAV embodiment.

FIG. 3 is a high-level block diagram illustrating the key onboard electronic and processing components of a generic autonomous agent.

FIG. 4 is a flowchart depicting an exemplary AI-driven decision-making loop.

FIG. 5 is an illustrative diagram showing a UAV cluster operating within a geofenced airport environment.

FIG. 6 is a conceptual diagram illustrating multi-modal deterrent engagement by a single UAV against avian targets.

FIG. 7 is a detailed view of an exemplary laser deterrent payload module.

FIG. 8 is a detailed view of an exemplary acoustic deterrent payload module.

FIG. 9 is a conceptual data pipeline diagram showing the flow of information from sensor data acquisition through AI analysis and command execution.

FIG. 10 is a diagram illustrating the cluster deployment and rotation concept for persistent operation.

FIG. 11 is a conceptual diagram illustrating a swarm of UAVs executing a cooperative “herding” maneuver.

FIG. 12 is a conceptual diagram illustrating a UAV swarm executing a cooperative “flush-and-ambush” tactic.

FIG. 13 is a conceptual diagram illustrating an autonomous cyber agent swarm executing Moving Target Defense (MTD) tactics within a digital network topology.

FIG. 14 is a flow diagram illustrating the game-theoretic decision-making process for the cyber agent swarm.

### DETAILED DESCRIPTION OF THE INVENTION

### I. System Architecture and Operating Environment

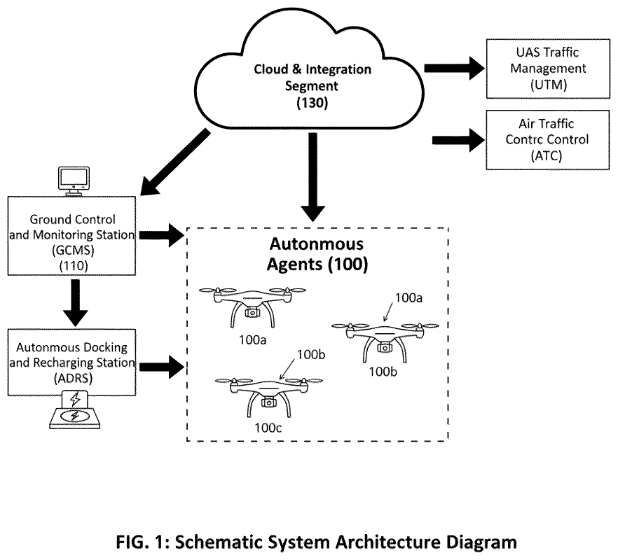

The present invention provides a comprehensive, platform-agnostic system and method for the autonomous, cooperative, and adaptive command and control of a plurality of autonomous agents. As illustrated in FIG. 1, the system is architected for persistent, 24/7 operation in a variety of sensitive environments. The architecture may be organized into three primary segments: the Agent Segment, the Control Segment, and the Cloud & Integration Segment.

The Agent Segment comprises a fleet or cluster of autonomous agents (100). In a preferred embodiment, a managed cluster of a plurality of agents (e.g., 100a, 100b, 100c) is assigned to each operational zone, enabling persistent coverage and high reliability through redundancy. The agents may be physical, such as unmanned aerial vehicles (UAVs), or virtual, such as autonomous software processes operating within a digital network.

The Control Segment provides command, control, and logistical support. It consists of a Ground Control and Monitoring Station (GCMS) (110) and, for physical embodiments, a network of Autonomous Docking and Recharging Stations (ADRS) (120). The GCMS (110) serves as the central command node and human-machine interface. A crucial function of the GCMS is its role as the central hub in a Centralized Training, Decentralized Execution (CTDE) architecture. This hybrid model is a key design choice that balances the need for global, fleet-wide learning with the need for robust, real-time execution in the field. In the centralized training phase, the GCMS aggregates mission data, sensor logs, and tactical outcomes from the entire fleet. This global dataset is used to train, refine, and update the core AI models, allowing the system to learn from a vast and diverse set of encounters. These improved models are then distributed to the individual agents. During mission execution, however, the agents operate in a decentralized fashion, executing their learned policies based on local observations without requiring constant, low-latency communication with the GCMS. This architecture is particularly advantageous in environments with intermittent communication, as it combines the benefits of global optimization with the robustness of decentralized control.

The Cloud & Integration Segment (130) acts as the centralized data repository and analytics backbone for long-term, fleet-wide learning and facilitates integration with third-party systems, such as Unmanned Aircraft System (UAS) Traffic Management (UTM) frameworks (140) and Air Traffic Control (ATC) systems (150) for safe airspace deconfliction.

### II. Core AI Framework: Multi-Agent Reinforcement Learning

The “brain” of each agent is an onboard Autonomous Control System (ACS) which includes a Decision-Making Subsystem. This subsystem is powered by a Multi-Agent Reinforcement Learning (MARL) framework, which enables the agents to learn complex, cooperative behaviors through interaction with their environment. The MARL model comprises a learned policy, typically embodied as a deep neural network, that maps an agent's local observations to a specific action or sequence of actions to maximize a cumulative reward.

In a preferred, non-limiting embodiment, the MARL framework is implemented using the Multi-Agent Deep Deterministic Policy Gradient (MADDPG) algorithm. MADDPG is an actor-critic, off-policy algorithm well-suited for environments with both cooperative and competitive elements and continuous action spaces, which are characteristic of the invention's applications. The architecture of MADDPG, which uses a centralized critic during training and decentralized actors during execution, maps directly to the invention's CTDE system architecture. During training, each agent's critic network has access to the observations and actions of all agents, allowing it to learn a global action-value function, Qᵢ (s, a₁, . . . , a_{N}). During execution, each agent's actor network selects actions based only on its own local observations, aᵢ=μᵢ(oᵢ). This allows for complex coordinated behavior to be learned centrally while execution remains scalable and robust.

To enable a person of ordinary skill in the art (POSITA) to practice the invention, the state space, action space, and reward function must be defined with specificity. The State Space(S) encompasses all observable parameters defining the environment and the agents' status. For a physical UAV agent in a wildlife deterrence embodiment, the state vector for agent i, sᵢ, may include its own kinematic state (position, velocity), battery level, current payload status, and assigned role, as well as the observed state of the target (e.g., species, flock size, centroid position, velocity vector) and the states of other friendly agents in the cluster. An exemplary state vector could be represented as:

sᵢ=[xᵢ,yᵢ,zᵢ,vₓᵢ,v_{yi},v_{zi},rollᵢ,pitchᵢ,yawᵢ,batteryᵢ,payload_modeᵢ,roleᵢ,species_id,flock_centroidₓ, . . . ,neighbor_M_pose].

For a virtual cyber agent, the state includes network traffic metadata, host-level data, security alerts, and the status and roles of other agents in the cyber swarm.

The Action Space (A) defines the set of all possible actions an agent can execute. For a UAV agent, this is typically a continuous action space represented by a vector controlling its velocity and payload parameters, e.g., aᵢ=[\dot{p}_{x,target}, \dot{p}_{y,target}, \dot{p}_{z,target}, P_{laser_pattern}, P_{acoustic_db}]. For a virtual cyber agent, the action space is typically discrete, including actions such as BLOCK_IP, REROUTE_TRAFFIC, or DEPLOY_DECOY_X.

The Reward Function (R) is meticulously engineered to incentivize the desired cooperative and unpredictable behaviors that solve the core technical problems. It is a weighted sum of terms for mission success, penalties for undesirable behavior, and efficiency costs. For the wildlife deterrence embodiment, the reward function for agent i at time t can be formulated as: Rᵢ(t)=w_{disp}·f_{disp}(t)−wᵣₑₚ·fᵣₑₚ(t)−wₑₙₑᵣ·fₑₙₑᵣ(t)+w_{coop}·f_{coop}(t), where f_{disp}(t) is a large positive reward for successful target dispersal; fᵣₑₚ(t) is a penalty if the agent's action sequence contributes to repetition within a sliding window, directly enforcing the non-repetition criterion; fₑₙₑᵣ(t) is a small penalty proportional to the energy consumed; and f_{coop}(t) is a team-based reward shared among agents for executing coordinated maneuvers, encouraging cooperation. This engineered reward function guides the MARL algorithm to learn policies that are not only effective but also unpredictable and efficient.

To further enable a POSITA, Table 1 provides exemplary, non-limiting hyperparameters for implementing the actor and critic neural networks within the MADDPG framework. These parameters provide a workable starting point for training the models in a simulated environment, thereby reducing the need for undue experimentation.

TABLE 1
Exemplary MARL (MADDPG) Implementation Parameters

| Hyperparameter | Actor Network | Critic Network | General |
|---|---|---|---|
| Optimizer | Adam | Adam | - |
| Learning Rate | 1 × 10⁻⁴ | 1 × 10⁻³ | |
| Hidden Layers | 2 | 2 | - |
| Nodes per Layer | 256,256 | 256,256 | - |
| Activation | ReLU | ReLU | - |
| Function | | | |
| Output Activation | Tanh | Linear | - |
| Discount Factor | - | - | 0.99 |
| (γ) | | | |
| Replay Buffer | - | - | 1 × 10⁶ |
| Size | | | |
| Batch Size | - | - | 1024 |
| Target | - | - | 0.01 |
| Smooth | | | |
| Factor (τ) | | | |

### III. Embodiment: Cooperative Wildlife Deterrence

### A. Behavioral Biomimicry and Dynamic Role Assignment

A principal embodiment of the invention is a system for wildlife deterrence that overcomes habituation by implementing “behavioral biomimicry.” The AI controller orchestrates the cluster of UAV agents to perform complex, cooperative behaviors that mimic the sophisticated hunting strategies of social predators, creating a deterrent that is exceptionally difficult for target wildlife to predict or ignore.

The system's most advanced operational mode is modeled on the well-documented cooperative hunting behavior of the Harris's hawk (Parabuteo unicinctus), a raptor known for its complex social structure and hunting parties. Ethological studies have identified several coordinated tactics that form the biological basis for the invention's AI-driven strategies, including the “flush-and-ambush” and “relay attack” maneuvers. The invention's AI controller generates these complex predator tactics as emergent behaviors through its MARL framework, enabled by dynamic role assignment. Based on the real-time tactical situation, the ACS assigns specific, temporary roles to individual UAVs. These roles are directly analogous to those observed in Harris's hawk hunting parties and may include, without limitation: a Flusher role to drive wildlife from cover; an Ambusher role to position at a predicted escape route; a Chaser role to apply active pursuit pressure; a Herder role to steer a flock; and a Sentinel role for high-altitude overwatch.

Referring to FIG. 12, an exemplary “flush-and-ambush” maneuver is illustrated. The ACS detects a target flock in a wooded area and assigns UAV (100a) the “flusher” role and UAVs (100b) and (100c) “ambusher” roles. As the flusher pressures the birds, they flee and are immediately confronted by the ambushers, creating a multi-directional, inescapable-seeming threat. This coordinated, multi-role tactic is a significant departure from the single threat vector of prior art systems and is central to solving the habituation problem.

### B. Co-Evolutionary Adaptation Module (CEAM) for Proactive Anti-Habituation

To overcome the limitations of relying on a fixed set of biologically-inspired tactics, the system further comprises a Co-Evolutionary Adaptation Module (CEAM). The CEAM is a novel component of the AI processing unit that moves beyond simple biomimicry to create a dynamic, co-evolutionary “arms race” with the target species. This computational approach embodies a “Red Queen” dynamic, where the deterrent system must continuously evolve its strategies simply to maintain its effectiveness against the adapting target.

The CEAM maintains a predictive habituation model for the target wildlife, which is continuously updated based on observed responses to deterrent stimuli. This model learns the target's patterns of adaptation by tracking key behavioral metrics such as response latency, return frequency to a protected zone, and flight initiation distance (FID).⁴ The model uses these inputs to generate a predicted efficacy score for any given deterrent tactic.

The CEAM then uses a Genetic Algorithm (GA) to computationally evolve new, unpredictable deterrent tactics. The GA operates on a population of candidate tactic sequences, where each tactic is encoded as a “chromosome”.^{y} The algorithm iteratively applies biologically inspired operators such as selection, crossover, and mutation to discover novel strategies. The process is not one of optimizing against a static goal. Instead, the fitness of each candidate tactic is evaluated by the predictive habituation model itself. The GA seeks to find tactics that the predictive model flags as highly effective against the current adaptive state of the target wildlife. This creates a powerful feedback loop: the system deploys a tactic, observes the response, updates its predictive model of what is currently effective, and then uses the GA to generate a new tactic optimized for the updated model. This co-evolutionary dynamic, where the system's evolution is driven by the predicted evolution of its target, ensures the deterrent strategy continuously evolves, preventing the long-term habituation that plagues prior art systems. It functions as a self-tuning threat generator, where the objective function for optimization is itself learned and adapted over time.

To enable a POSITA to implement the CEAM, the structure of the GA is specified. A deterrent tactic sequence is encoded as a fixed-length vector, or “chromosome.” The fitness of each chromosome is evaluated using the predictive habituation model, and the GA seeks to find chromosomes that maximize this fitness score.

TABLE 2
Genetic Algorithm (CEAM) Chromosome Representation

| Component | Description |
|---|---|
| Chromosome | A deterrent tactic sequence is a fixed- |
| Representation | length vector. For a 3-agent swarm over |
| | 2 steps. Roles map to integers; targets |
| | are coordinates; payloads include |
| | (pattern, duty cycle/SPL). |
| Fitness | Fitness = Score_{habituation} (chromosome) |
| Function | from the predictive model; maximize |
| | predicted novelty/disruption. |
| Genetic | Tournament selection; two-point |
| Operators | crossover; mutation probability 0.05; |
| | elitism retains top individuals. |

TABLE 3
Exemplary Genetic Algorithm (CEAM) Parameters

| Parameter | Exemplary Value | Rationale |
|---|---|---|
| Population | 1000 | Provides sufficient |
| Size | individuals | diversity for exploring the |
| | | complex search space of |
| | | multi-agent tactics. |
| Selection | Tournament | An effective and |
| Method | Selection | commonly used method |
| | | for maintaining selection |
| | | pressure. |
| Crossover | 0.8 | A standard value that |
| Rate | | encourages |
| | | recombination of |
| | | successful tactic |
| | | components. |
| Mutation | 0.05 | A standard value to |
| Rate | | introduce variation |
| | | without disrupting the |
| | | convergence of the |
| | | algorithm. |
| Elitism | Yes (Top 5% of | Ensures that the best- |
| | population) | performing tactics |
| | | discovered are not lost |
| | | between generations. |

### IV. Embodiment: Proactive Cybersecurity Via Moving Target Defense

### A. Autonomous Cyber Agent Swarm

In another embodiment, the core principles of cooperative, unpredictable, multi-agent action are applied to cybersecurity. The system is configured as a proactive network defense platform that overcomes the limitations of static defenses. The “unmanned vehicles” are embodied as “autonomous software agents,” the “operational area” is a “digital network topology,” and the “payloads” are “cyber payloads” such as network control actions. The unpredictable, coordinated actions of the cyber agent swarm create a dynamic and confusing environment for an attacker, a concept known as Moving Target Defense (MTD). The fundamental goal of MTD is to make the network's attack surface a constantly shifting, ephemeral target, thereby increasing the cost and complexity for an attacker while invalidating their reconnaissance efforts. The swarm's emergent behavior achieves this by cooperatively and dynamically changing network configurations (e.g., re-assigning IP addresses, altering routing tables), modifying system attributes, or deploying and retracting deceptive assets.

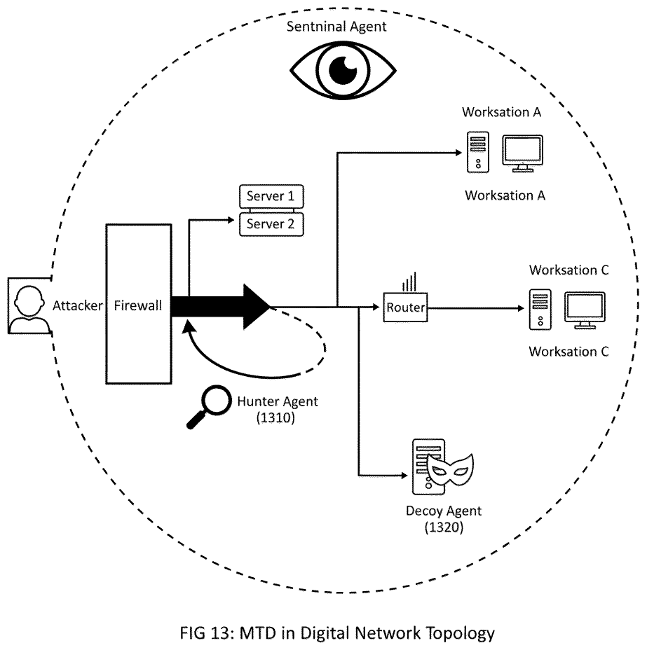

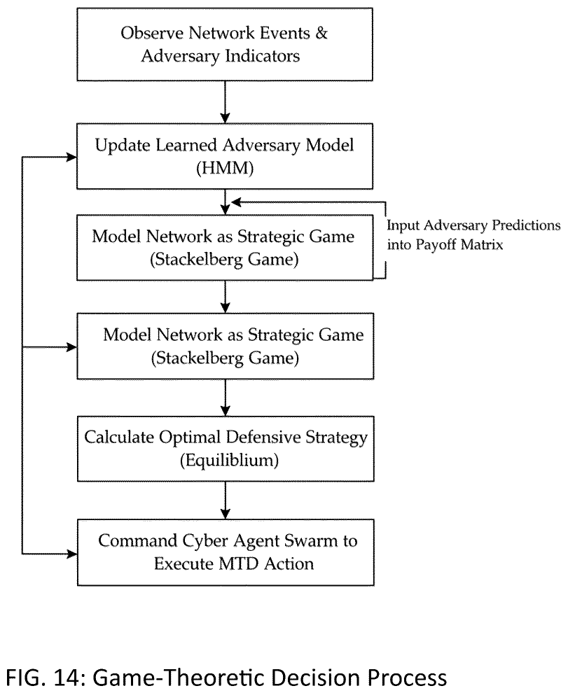

Similar to the wildlife embodiment, the AI dynamically assigns roles to the software agents. As shown in FIG. 13, these roles may include: “Hunter” Agents (1310) that autonomously patrol network segments for indicators of compromise; “Decoy” Agents (1320) that create and manage dynamic, high-interaction honeypots that can mimic critical assets like industrial control systems (ICS); and “Sentinel” Agents (1330) that perform high-level, aggregate monitoring for large-scale anomalies.

### B. Predictive Game-Theoretic Defense Framework

A further embodiment enhances the cybersecurity application by integrating the principles of Game Theory into the swarm's decision-making process, elevating the system from a merely adaptive swarm to a strategically rational adversary. This combination elevates the system from being merely adaptive to being strategically rational and predictive. It does not simply react to an attack or randomly shuffle IPs; it builds a procedural model of its specific opponent and makes a provably optimal move to counter that opponent's most likely next action.

The interaction between the defensive agent swarm and a malicious attacker is formally modeled as a Bayesian Stackelberg Game. In this model, the defender acts as the “leader” and commits to a randomized MTD strategy first. The attacker, or “follower,” who may be of one of several “types” with an unknown prior probability, observes the defender's strategy and plays a best response to maximize their own utility. This leader-follower model accurately reflects the asymmetry of many cyber conflicts, where the defender must establish a defensive posture before an attack occurs.

A key innovation is that the system does not play against a generic, theoretically rational attacker. Instead, it first learns a predictive model of the specific adversary's TTPs. In a preferred, non-limiting implementation, a Hidden Markov Model (HMM) is used for this purpose. The HMM is structured to model the stages of a cyber-attack, such as those defined in the Cyber Kill Chain framework. The HMM infers the attacker's current, hidden stage in the kill chain based on a sequence of observable events, such as alerts from an Intrusion Detection System (IDS).

The true novelty lies in the dynamic feedback loop created between the HMM and the game-theoretic engine. The output of the HMM—specifically, the probability distribution over the attacker's current (hidden) state in the kill chain—becomes a critical input parameter for the utility calculations in the Stackelberg game's payoff matrix. This allows the system to optimize its MTD strategy in real-time against the predicted next move of the actual adversary. For example, if IDS alerts cause the HMM to infer a high probability that the attacker is in the “Reconnaissance” stage, the game engine will calculate an optimal MTD strategy to counter reconnaissance, such as deploying a low-interaction decoy. If subsequent alerts cause the HMM to update its belief to the “Exploitation” stage, the game engine re-optimizes and may select a different strategy, such as migrating a critical service. The system doesn't just react; it predicts and proactively reconfigures the network to minimize the adversary's expected payoff for their most probable next course of action. This fusion of probabilistic inference (HMM) with strategic optimization (Game Theory) creates a defense that is proactive, predictive, and mathematically optimized against a modeled adversary.

TABLE 4
Hidden Markov Model (HMM) Structure for Cyber Kill Chain Modeling

| HMM Component | Definition in Context of Invention |
|---|---|
| Hidden States (S) | The discrete stages of the Cyber Kill |
| | Chain: {Reconnaissance, |
| | Weaponization, Delivery, Exploitation, |
| | Installation, Command-and-Control, |
| | Actions-on-Objectives}. |
| Observations (0) | A vocabulary of discrete alert types from |
| | an IDS/SIEM: {PortScan, |
| | BruteForceSSH, ExploitAttempt, |
| | Beaconing, LateralMovement, PrivEsc, |
| | DataExfiltration}. |
| Transition Matrix (A) | An S × S matrix where Aᵢⱼ = P(Sₜ₊₁ = |
| | j\|Sₜ = i). |
| Emission Matrix (B) | An S × 0 matrix where Bᵢₖ = P(Oₜ = |
| | k\|Sₜ = i). |
| Initial Distribution (It) | A vector where πᵢ = P(S₁ = i). This is the |
| | initial probability distribution over the |
| | states, typically with a high probability |
| | for the Reconnaissance state. |

TABLE 5
Stackelberg Game Payoff Matrix Formulation

| | Mathematical Formulation and |
|---|---|
| Component | Description |
| Players | Defender (Leader), Attacker (Follower). |
| Defender Actions | A set of available MTD strategies, e.g., |
| (d ∈ D) | d₁: IP Address Shuffling, d₂: OS Version |
| | Randomization, d₃: Deploy High- |
| | Interaction Decoy. |
| Attacker Actions | A set of available attack vectors, e.g., |
| (a ∈ A) | a₁: Exploit CVE-X, a₂: Brute Force SSH. |
| Defender Utility | The defender's utility is a function of |
| (U_{D}(d, a)) | asset value, the probability of a |
| | successful attack, and the cost of the |
| | defensive action: U_{D} (d, a) = Vₐₛₛₑₜ · (1 - |
| | P_{success}(d, a)) - C_{MTD}(d). Vₐₛₛₑₜ: Quantified |
| | value of the asset being protected. |
| | P_{success}(d, a): The probability of attack a |
| | succeeding against defense d. This |
| | probability is directly informed by the |
| | HMM's output. For example, if the HMM |
| | indicates a high probability that the |
| | attacker is in the S₃: Exploitation state, |
| | the P_{success} for exploit-based attacks |
| | against relevant MTDs is dynamically |
| | increased in the utility calculation. |
| | C_{MTD}(d): The operational cost (e.g., |
| | performance overhead, administrative |
| | effort) of implementing MTD strategy d. |
| Attacker Utility | The attacker's utility is a function of the |
| (U_{A}(d, a)) | asset value, the probability of success, |
| | and the cost of the attack: U_{A}(d, a) = |
| | Vₐₛₛₑₜ · P_{success}(d, a) - C_{attack}(a). Vₐₛₛₑₜ: |
| | Value of the asset to the attacker. |
| | P_{success}(d, a): Same HMM-informed |
| | probability as above. C_{attack}(a): The cost |
| | or effort for the attacker to execute |
| | attack a. |

### V. Embodiment: Proactive Event and Perimeter Security

In this embodiment, the system is configured to provide intelligent, cooperative security for outdoor public events or for the perimeter defense of critical infrastructure. The UAV swarm acts as a sentient network of security assets, performing coordinated patrols and providing real-time intelligence.

A novel aspect of this embodiment is the application of a Predictive Threat Vector Analysis module, which is analogous to the predictive adversarial modeling used in the cybersecurity embodiment. The system ingests data about the physical environment (e.g., building layouts, terrain, lines of sight) and real-time data on crowd movement and density. The AI processing unit uses this information to build a predictive model of potential threat behaviors, identifying high-probability threat vectors such as optimal sniper locations or likely ingress/egress routes for an attacker. The MARL-controlled swarm then uses this predictive model to proactively adjust its surveillance patterns, dynamically allocating more resources to monitor these high-risk areas. This transforms surveillance from a reactive or pre-programmed function into a proactive, anticipatory capability that can anticipate threats before they materialize.

### VI. Additional Embodiments and Implementations

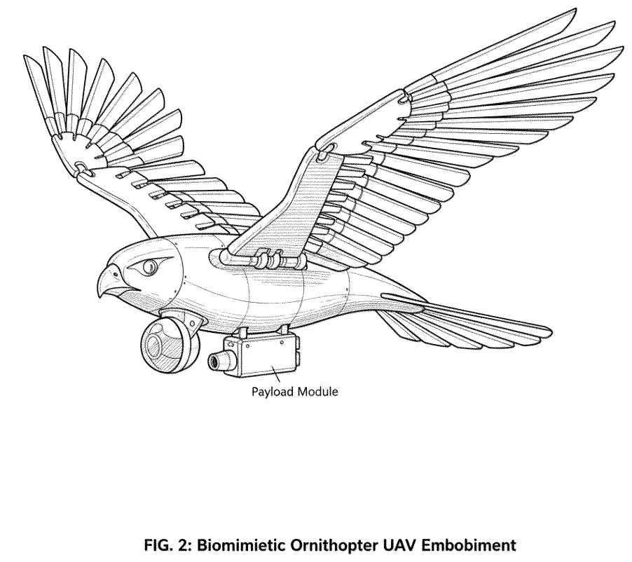

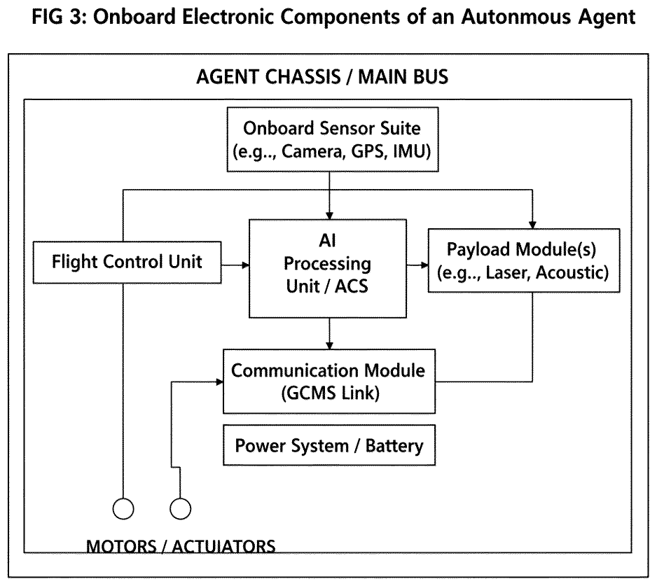

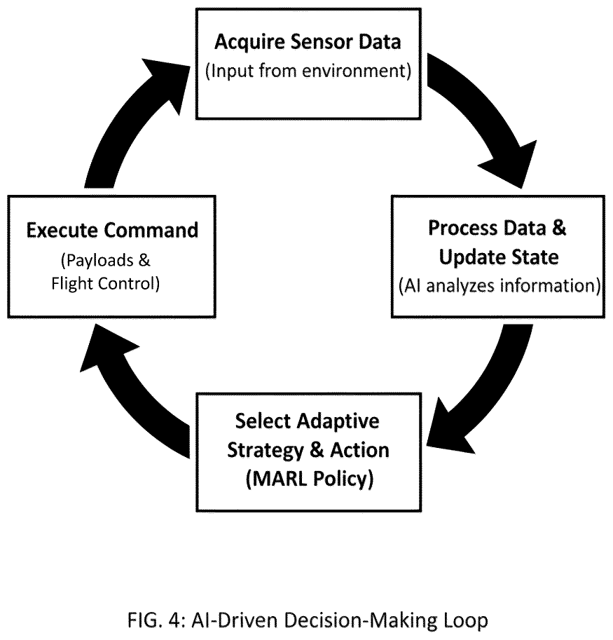

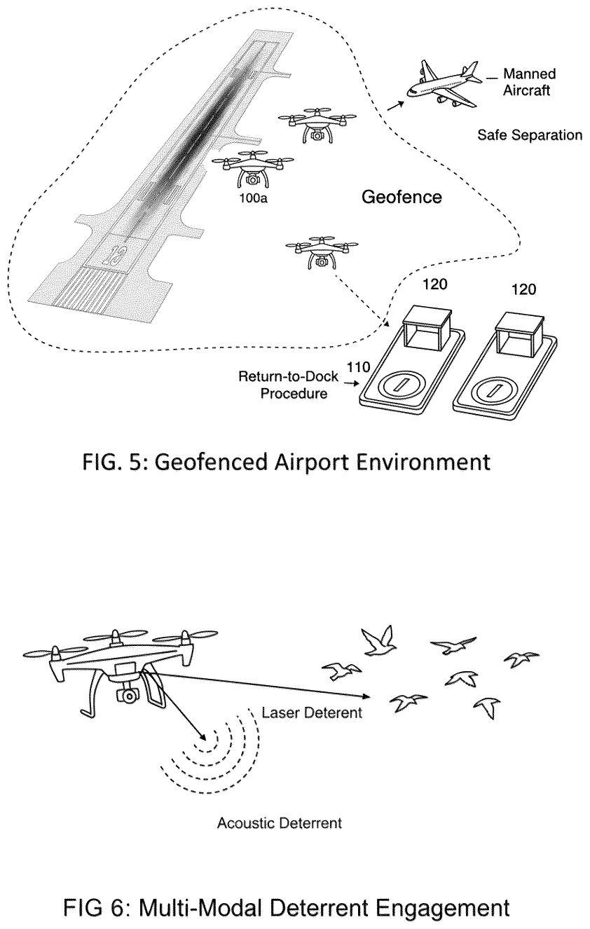

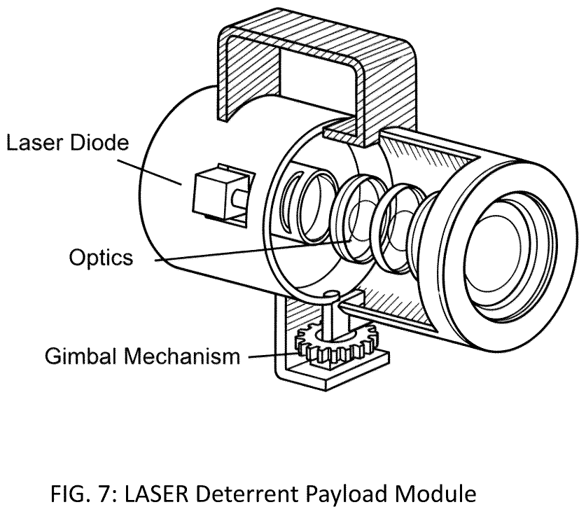

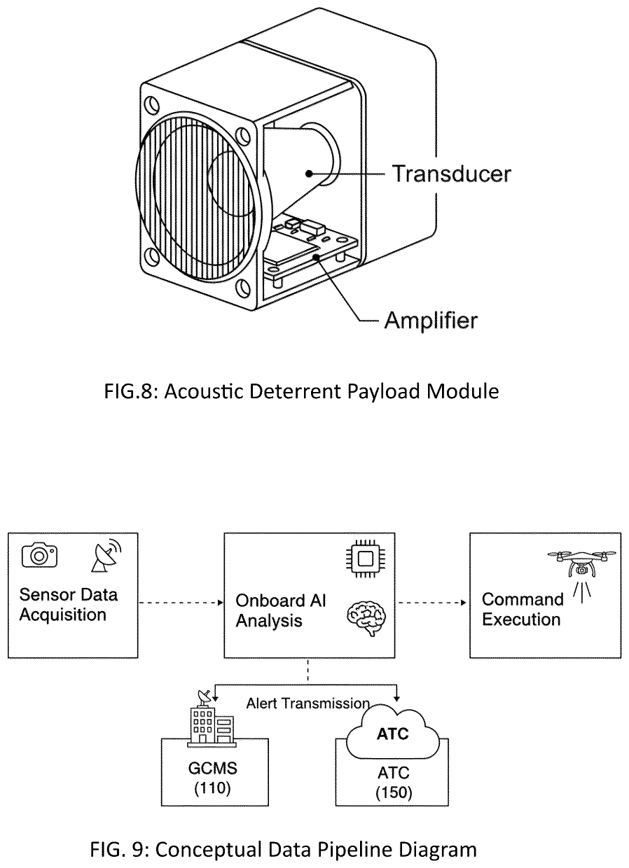

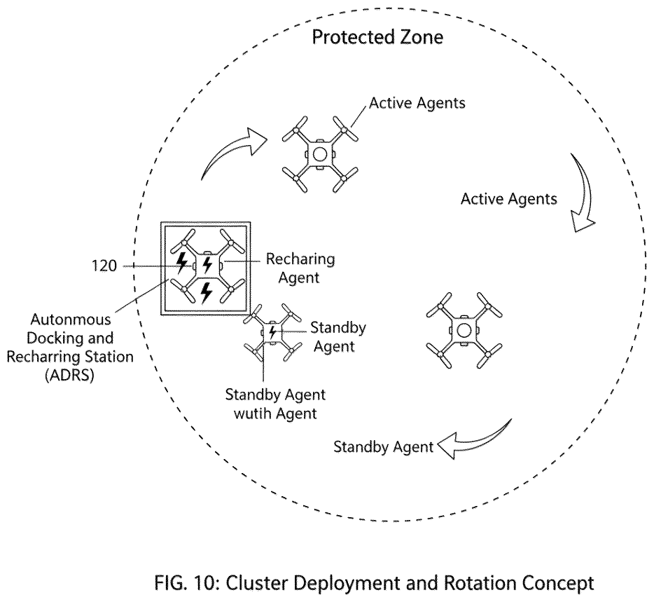

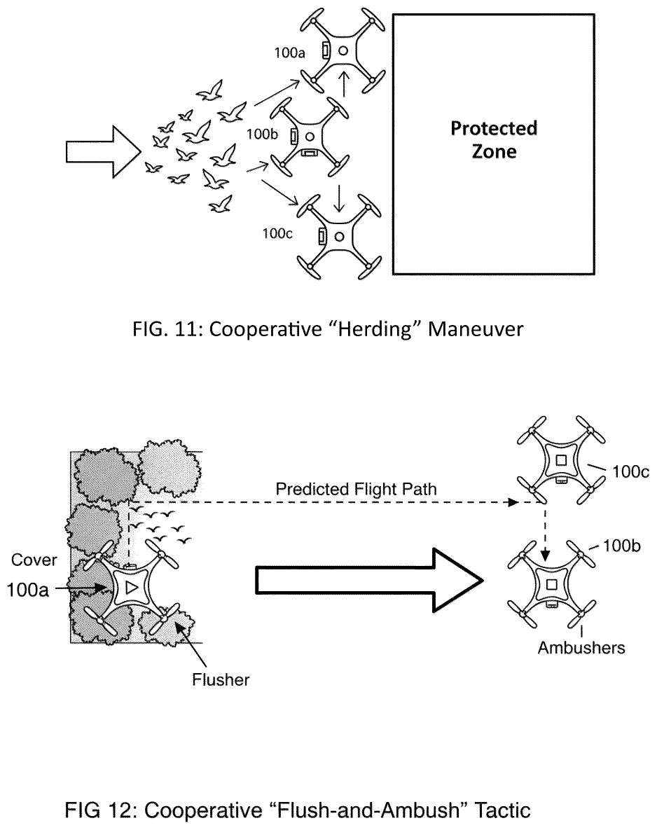

The principles of the invention are applicable to numerous other domains. In a Wind Farm Deployment, the system is used to proactively address avian collisions with wind turbines. Upon detection of approaching flocks, the UAV swarm is dispatched to execute cooperative herding maneuvers, guiding the wildlife safely around the turbine array, thereby protecting wildlife while minimizing costly curtailment. In an Agriculture Deployment, the system provides persistent, 24/7 protection for high-value crops from avian pests. In an Aquaculture Deployment, the system addresses the acute habituation challenge posed by piscivorous birds. A swarm of biomimetic ornithopter agents (FIG. 2) can execute authentic cooperative hunting tactics, creating a high-stress, authentic predatory threat that is far more effective at deterring highly motivated and habituated birds.

What is claimed is:

1. An autonomous deterrence and management system comprising:
(a) a managed cluster of a plurality of autonomous agents; each agent comprising:
(i) an onboard sensor suite configured to acquire data corresponding to one or more targets within an operational area;
(ii) an onboard artificial-intelligence (AI) processing unit communicatively coupled to a control unit and to the onboard sensor suite; and
(iii) one or more integrated payloads;
(b) wherein the AI processing unit is configured to command the managed cluster to execute a cooperative swarm behavior that includes:
(i) dynamically assigning a first role to a first autonomous agent and a second role to a second autonomous agent based on an adaptive strategy selected to achieve a quantified mission objective for the operational area, the quantified mission objective being selected from the group consisting of:
(A) a reduction in habituation of the one or more targets, wherein the AI processing unit is further configured to:
(1) maintain a predictive habituation model that maps a vector of target response features, the vector comprising at least a response latency and a return frequency, to a predicted efficacy score for a given deterrent tactic sequence; and
(2) generate the adaptive strategy via a co-evolutionary process comprising a genetic algorithm that mutates a library of baseline tactic sequences, wherein a fitness function for the genetic algorithm is based on maximizing the predicted efficacy score from the predictive habituation model;
the reduction in habituation being measured by at least one of: (I) an increase in an average response latency of the one or more targets to a deterrent stimulus by at least 20% relative to a baseline period, or (II) a decrease in a return frequency of the one or more targets to a protected zone by at least 50% within 24 hours after an initial dispersal;
(B) a security-response objective, wherein the adaptive strategy comprises proactively adjusting patrol patterns based on a predictive threat model that identifies high-probability threat vectors within the operational area, the objective being measured by at least one of: (I) a detection confidence exceeding a threshold, (II) a time-to-alert not greater than a threshold, or (III) a track-continuity rate not less than a threshold over a defined window; or
(C) a cyber-resiliency objective, wherein the AI processing unit is further configured to:
(1) generate a learned predictive model of an adversary's tactics, the learned predictive model comprising a hidden Markov model for predicting a next attack step in a cyber kill chain based on a sequence of observed network events from an intrusion detection system; and
(2) select the adaptive strategy by modeling an interaction with the adversary as a strategic game, the strategic game comprising a Stackelberg game payoff matrix wherein a defender utility is a function of a quantified asset value and a moving-target-defense reconfiguration cost, and wherein an attacker utility is a function of a predicted probability of success derived from the learned hidden Markov model;
the objective being measured by at least one of: (I) a reduction of scan-success probability below a threshold, (II) an increase in attack-path length by at least a threshold, or (III) an increase in mean time-to-compromise by at least a threshold; and
(ii) generating coordinated maneuvers that satisfy a non-repetition criterion, wherein the non-repetition criterion requires that no generated action sequence, defined as a tuple of agent roles, velocity vectors, and payload states, is repeated verbatim within a configurable sliding window of a predetermined number of preceding action sequences.

2. The system of claim 1, wherein the managed cluster comprises at least three autonomous agents.

3. The system of claim 1, wherein the autonomous agents are unmanned aerial vehicles (UAVs), the operational area is a physical environment, and the one or more targets are wildlife.

4. The system of claim 3, wherein the cooperative swarm behavior comprises behavioral biomimicry, and the dynamic assignment comprises assigning a role selected from the group consisting of a flusher role, an ambusher role, a chaser role, a herder role, and a sentinel role to execute tactics modeled on cooperative hunting strategies of the Harris's hawk (Parabuteo unicinctus).

5. The system of claim 4, wherein the coordinated maneuvers comprise a flush-and-ambush maneuver in which the first autonomous agent assigned the flusher role drives wildlife from cover toward the second autonomous agent assigned the ambusher role.

6. The system of claim 4, wherein the coordinated maneuvers comprise a relay-attack maneuver in which a plurality of autonomous agents assigned the chaser role sequentially apply pursuit pressure to the wildlife.

7. The system of claim 3, wherein at least one autonomous agent is an ornithopter comprising a biomimetic airframe and a flapping-wing propulsion system configured to mimic a flight profile of an avian predator.

8. The system of claim 1, wherein the autonomous agents are configured for event or perimeter security, the sensor suite comprises at least one of a visible-light camera, an infrared imager, or a microphone array, and the AI processing unit is configured to analyze fused sensor data for anomalies indicative of a security threat.

9. The system of claim 1, further comprising a ground control and monitoring station (GCMS) configured to manage deployment of the managed cluster and to serve as a central node in a centralized-training, decentralized-execution (CTDE) framework that aggregates data from the plurality of autonomous agents to train a global model distributed to the plurality of autonomous agents.

10. The system of claim 1, further comprising a network of autonomous docking and recharging stations (ADRS) managed by the GCMS to rotate active, standby, and recharging states among the plurality of autonomous agents to provide persistent coverage.

11. The system of claim 1, wherein the autonomous agents are autonomous software agents, the operational area is a digital network topology, and the cooperative swarm behavior comprises implementing a moving-target defense by performing at least one network control action selected from the group consisting of: reassigning Internet Protocol addresses within a defined address pool, reconfiguring software-defined-networking flows to alter routing tables, modifying network segmentation rules, and instantiating or retiring decoy virtual machines.

12. The system of claim 11, wherein the dynamic assignment comprises assigning a role selected from the group consisting of a Hunter agent role configured to patrol network segments for malicious activity, a Decoy agent role configured to create and manage dynamic honeypots, and a Sentinel agent role configured to monitor aggregate network traffic for anomalies.

13. The system of claim 12, wherein a decoy honeypot is configured to mimic an industrial-control-system server by emulating at least one of a Modbus or DNP3 protocol and corresponding data structures.

14. The system of claim 11, wherein the AI processing unit is further configured to model interactions within the digital network topology as a strategic game and to select the adaptive strategy by calculating a strategic equilibrium selected from the group consisting of a Nash equilibrium and a Stackelberg equilibrium.

15. A non-transitory computer-readable medium storing instructions that, when executed by one or more processors of an autonomous agent, cause the processors to:
(a) receive observations from a sensor suite;
(b) compute, using a multi-agent reinforcement-learning policy, a role selected from the group consisting of flusher, ambusher, chaser, herder, and sentinel;
(c) generate an action sequence that satisfies a non-repetition criterion within a sliding window by prohibiting repetition of any generated action sequence verbatim within the window; and
(d) command a payload or network control action to implement the action sequence.

16. A method of autonomous and cooperative wildlife deterrence, comprising:
(a) deploying a managed cluster of a plurality of unmanned aerial vehicles (UAVs), each with a sensor suite and an onboard AI processing unit;
(b) detecting, via the sensor suite, one or more wildlife targets in an operational area;
(c) maintaining, by at least one AI processing unit, a predictive habituation model that maps a vector of target response features, the vector comprising at least a response latency and a return frequency, to a predicted efficacy score for a given deterrent tactic sequence;
(d) generating, by the at least one AI processing unit, a cooperative deterrent strategy via a co-evolutionary process comprising a genetic algorithm that mutates a library of baseline tactic sequences, wherein a fitness function for the genetic algorithm is based on maximizing the predicted efficacy score from the predictive habituation model to achieve a quantified mission objective comprising a reduction in habituation measured by at least one of: (1) an increase in an average response latency of the wildlife to a deterrent stimulus by at least 20% relative to a baseline period, or (2) a decrease in a return frequency of the wildlife to a protected zone by at least 50% within 24 hours after an initial dispersal;
(e) assigning a first role to a first UAV and a second role to a second UAV based on the generated cooperative deterrent strategy; and
(f) commanding the UAVs to execute coordinated maneuvers that satisfy a non-repetition criterion within a sliding window.

17. The method of claim 16, further comprising:
(a) logging responses of the wildlife to the coordinated maneuvers; and
(b) using the logged responses within a reinforcement-learning framework to refine subsequent selections of the cooperative deterrent strategy.

18. A method of proactive cyber defense, comprising:
(a) generating, by one or more processors, a learned predictive model of at least one malicious actor's tactics, the learned predictive model comprising a hidden Markov model for predicting a next attack step in a cyber kill chain based on a sequence of observed network events;
(b) modeling, by the one or more processors, an interaction between a swarm of defensive software agents and the at least one malicious actor as a dynamic strategic game, the dynamic strategic game comprising a Stackelberg game payoff matrix wherein a defender utility is a function of a quantified asset value and a moving-target-defense reconfiguration cost, and wherein an attacker utility is a function of a predicted probability of success derived from the learned hidden Markov model;
(c) predicting, by the one or more processors, a probable course of action for the at least one malicious actor based on the dynamic strategic game; and
(d) commanding, by the one or more processors, the swarm to execute a defensive strategy selected by a multi-agent reinforcement-learning model to counter the predicted course of action, the defensive strategy comprising at least one network control action selected from the group consisting of Internet Protocol address reassignment, software-defined-networking route reconfiguration, modification of network segmentation rules, and instantiation of a decoy virtual machine.

19. The method of claim 18, wherein executing the defensive strategy comprises deploying a decoy agent configured to present strategically crafted false information to manipulate a decision-making process of the at least one malicious actor.

20. The method of claim 19, wherein the strategically crafted false information is generated by a generative AI model fine-tuned on datasets of network logs and attacker behaviors to create contextually realistic deceptive content.
